(19) United States
(12) Patent Application Publication
(10) Pub. No.: US 2007/0274756 A1
(43) Pub. Date: Nov. 29, 2007

(54) Ink ribbon cassette and printer including ink ribbon

(75) Inventor: Zenko Motoki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/512,868

(22) Filed: Aug. 29, 2006

(30) Foreign Application Priority Data
May 23, 2006 (JP) 2006-143154
May 23, 2006 (JP) 2006-143155

(51) Int. Cl. B41J 35/28

(52) U.S. Cl. 400/208

(57) ABSTRACT

An ink ribbon cassette includes a first case and a second case. Positioning holes for mounting the ink ribbon cassette in a cassette mounting unit of a printer are formed in either one of the first case and the second case.

### BACKGROUND OF THE INVENTION

1. Field of the Invention

The present invention generally relates to an ink ribbon cassette used in a line printer and, in particular, to an ink ribbon cassette that is capable of improving the precision of positioning the cassette when mounting the cassette in a printing apparatus. The present invention also relates to a printer including the ink ribbon cassette mounted in a cassette mounting unit thereof.

2. Description of the Related Art

In order to record print data, printers have been widely used that include a cassette mounting unit in which a ribbon cassette containing a desired ink ribbon is mounted by inserting the ribbon cassette through a cassette insertion port formed in frames of the printers (refer to, for example, Japanese Unexamined Patent Application Publication No. 2001-205905).

As shown in FIGS. 3 and 4, an ink ribbon cassette 31, which is an example of a known ink ribbon cassette, includes a first case 35 and a second case 43 that are fitted together, which rotatably support a supply core 33 with a long ink ribbon 32 wound therearound and a take-up core 34.

As shown in FIG. 4, the supply core 33 and the take-up core 34 are formed from substantially cylindrical resin members having the same size. The supply core 33 includes a cylindrical base portion 33a located in the middle in the axis direction, a small-diameter portion 33b located at one end in the axis direction and having an outer diameter smaller than that of the base portion 33a, and a large-diameter portion 33c located at the other end in the axis direction and having an outer diameter larger than that of the base portion 33a. A shaft 33d having a diameter smaller than that of the small-diameter portion 33b is coupled with the top end of the small-diameter portion 33b. Additionally, collar-like flanges 33e and 33f are integrally formed between the base portion 33a and the small-diameter portion 33b and between the base portion 33a and the large-diameter portion 33c, respectively. Similarly, the take-up core 34 includes a cylindrical base portion 34a located in the middle in the axis direction, a small-diameter portion 34b located at one end in the axis direction and having an outer diameter smaller than that of the base portion 34a, and a large-diameter portion 34c located at the other end in the axis direction and having an outer diameter larger than that of the base portion 34a. A shaft 34d having a diameter smaller than that of the small-diameter portion 34b is coupled with the top end of the small-diameter portion 34b. Additionally, collar-like flanges 34e and 34f are integrally formed between the base portion 34a and the small-diameter portion 34b and between the base portion 34a and the large-diameter portion 34c, respectively.

The first case 35 is formed from a resin material. As shown in FIGS. 3 and 4, the first case 35 includes a semi-cylindrical supply-side container 36, a semi-cylindrical take-up side container 37, a first side wall 38, and a second side wall 39. A first end of the supply-side container 36 and a first end of the take-up side container 37 in the lengthwise direction are coupled with the first side wall 38, whereas a second end of the supply-side container 36 and a second end of the take-up side container 37 in the lengthwise direction are coupled with the second side wall 39. Thus, the first case 35 is integrally formed. On the sides of the supply-side container 36 and the take-up side container 37 facing each other, a first ribbon guide 35a and a second ribbon guide 35b are integrally formed, respectively. Between the first ribbon guide 35a and the second ribbon guide 35b, an opening 40 is formed. The ink ribbon 32 is exposed through the opening 40. In addition, a guide roller clearance portion 41 is formed on the second ribbon guide 35b so as to extend in the lengthwise direction. When the ink ribbon cassette 31 is mounted in a printing apparatus (not shown), guide rollers (not shown) disposed on the printing apparatus to guide the ink ribbon 32 are in contact with the guide roller clearance portion 41.

As shown in FIG. 4, a semi-cylindrical shaft bearing 36a for rotatably supporting the large-diameter portion 33c of the supply core 33 and a semi-cylindrical shaft bearing 36b for rotatably supporting the shaft 33d of the supply core 33 are integrally formed in the supply-side container 36 of the first case 35. Additionally, a semi-cylindrical shaft bearing 37a for rotatably supporting the large-diameter portion 34c of the take-up core 34 and a semi-cylindrical shaft bearing 37b for rotatably supporting the shaft 34d of the take-up core 34 are integrally formed in the take-up side container 37 of the first case 35.

Furthermore, as shown in FIGS. 3 and 4, positioning holes 42a and 42b are formed in the second side wall 39 of the first case 35 with a predetermined spacing therebetween. When the ink ribbon cassette 31 is mounted in the printing apparatus, positioning pins (not shown) for positioning the ink ribbon cassette 31 in place in the printing apparatus are inserted into the positioning holes 42a and 42b.

Like the first case 35, the second case 43 is formed from a resin material. As shown in FIGS. 3 and 4, the second case 43 includes a semi-cylindrical supply-side container 44, a semi-cylindrical take-up side container 45, a first side wall 46, and a second side wall 47. A first end of the semi-cylindrical supply-side container 44 and a first end of the take-up side container 45 in the lengthwise direction are coupled with the first side wall 46, whereas a second end of the supply-side container 44 and a second end of the take-up side container 45 in the lengthwise direction are coupled with the second side wall 47. Thus, the second case 43 is integrally formed. On the sides of the supply-side container 44 and the take-up side container 45 facing each other, a first ribbon guide 43a and a second ribbon guide 43b are integrally formed, respectively. An opening 48 is formed between the first ribbon guide 43a and the second ribbon guide 43b. The ink ribbon 32 is exposed through the opening 48. In addition, in each of the first ribbon guide 43a and the second ribbon guide 43b, a gap is formed when the first case 35 and the second case 43 are fitted together so that the ink ribbon 32 can pass between the first ribbon guide 35a and the second ribbon guide 35b of the first case 35.

As shown in FIG. 4, in the supply-side container 44 of the second case 43, a semi-cylindrical shaft bearing 44a for rotatably supporting the large-diameter portion 33c of the supply core 33 and a semi-cylindrical shaft bearing 44b for rotatably supporting the shaft 33d of the supply core 33 are integrally formed. Additionally, in the take-up side container 45 of the second case 43, a semi-cylindrical shaft bearing 45a for rotatably supporting the large-diameter portion 34c of the take-up core 34 and a semi-cylindrical shaft bearing 45b for rotatably supporting the shaft 34d of the take-up core 34 are integrally formed.

Furthermore, as shown in FIGS. 3 and 4, positioning holes 49a and 49b are formed on the supply-side container 44 and the take-up side container 45 of the second case 43, respectively, with a predetermined spacing therebetween. When the ink ribbon cassette 31 is mounted in the printing apparatus, positioning pins (not shown) for positioning the ink ribbon cassette 31 in place in the printing apparatus are inserted into the positioning holes 49a and 49b.

A fitting member (not shown) for fitting the first case 35 to the second case 43 is integrally formed on each of the first case 35 and the second case 43. The shaft bearings 36a and 36b of the first case 35 and shaft bearings 44a and 44b of the second case 43 are disposed so as to rotatably support the supply core 33 with the ink ribbon 32 wound therearound. The shaft bearings 37a and 37b of the first case 35 and the shaft bearings 45a and 45b of the second case 43 are disposed so as to rotatably support the take-up core 34 with the ink ribbon 32 wound therearound. By fitting the first case 35 to the second case 43 using the fitting members, the ink ribbon cassette 31 is formed.

According to the known ink ribbon cassette 31 having such a structure, when the ink ribbon cassette 31 is mounted in the printing apparatus, the positioning pins attached to the printing apparatus are inserted into the positioning holes 42a and 42b formed in the second side wall 39 of the first case 35 and the positioning holes 49a and 49b formed in the supply-side container 44 and the take-up side container 45 of the second case 43. Thus, the ink ribbon cassette 31 can be mounted in place in the printing apparatus.

Additionally, after the ink ribbon 32 is completely used, the supply core 33 and the take-up core 34 with the used ink ribbon 32 wound therearound can be easily removed by disassembling the first case 35 and the second case 43. Thereafter, by installing a supply core 33 and a take-up core 34 with a new ink ribbon 32 wound therearound, the ink ribbon cassette 31 can be repeatedly used.

In addition, the printing apparatus includes a housing composed of metallic plates. A head mount is disposed on the housing. A thermal head formed as a line head is attached to the lower portion of the head mount so as to move upward and downward with respect to a platen roller. Furthermore, an insertion port having a shape substantially that of eye-glasses is formed on the front side wall of the housing. The insertion port allows a ribbon cassette to be inserted into the cassette mounting unit in the printing apparatus from the leading end of the ribbon cassette. First and second positioning pins are provided so as to extend perpendicularly from the outer surface of the front side wall with a predetermined pitch therebetween. The first and second positioning pins are used for determining the position of the trailing end of the ribbon cassette. Furthermore, a claw member (a latching member) is provided at a predetermined location on the front side wall in order to latch and secure the ribbon cassette disposed in the cassette mounting unit.

Furthermore, a supply bobbin and a take-up bobbin are rotatably disposed on the rear side wall of the housing. The supply bobbin and the take-up bobbin protrude into the cassette mounting unit of the printing apparatus and fit a supply shaft and a take-up shaft contained in the ribbon cassette, respectively. In order to determine the position of the leading end of the ribbon cassette, third and fourth positioning pins are provided so as to extend perpendicularly from an inner surface of the rear side wall with a predetermined pitch therebetween.

However, according to the known ink ribbon cassette 31, in order to mount the ink ribbon cassette 31 in place in the printing apparatus, the positioning holes 42a and 42b and the positioning holes 49a and 49b are formed in the first case 35 and the second case 43, respectively. Accordingly, depending on the accuracy with which the first case 35 and the second case 43 are formed, the positions of the positioning holes 42a, 42b, 49a, and 49b can slightly vary when the first case 35 and the second case 43 are fitted each other. As a result, the positioning accuracy of the ink ribbon cassette 31 in the printing apparatus can also vary, which is a problem.

Additionally, a guide member that guides the ribbon cassette to the cassette mounting unit along the insertion path when the ribbon cassette is inserted into the cassette mounting unit is not provided. Accordingly, the leading end of the ribbon cassette moving in the cassette mounting unit can become shifted. Therefore, in the deepest area of the cassette mounting unit, an operation to fit the first and second positioning holes formed on the ribbon cassette to the first and second positioning pins, respectively, and an operation to fit the supply bobbin and the take-up bobbin to the supply shaft and the take-up shaft, respectively, become difficult.

Furthermore, in the cassette mounting unit of the printing apparatus, while a separation roller for separating the ink ribbon used for recording from a recording paper sheet is provided on the side wall of the housing, the separation roller sometimes interferes with the mounting operation of the ribbon cassette.

### SUMMARY OF THE INVENTION

Accordingly, it is an object of the present invention to provide an ink ribbon cassette for improving the positional precision when the ribbon cassette is mounted in a printing apparatus and a printer including a mechanism for facilitating the mounting operation of the ink ribbon cassette in place in a cassette mounting unit of the printer.

According to an aspect of the present invention, an ink ribbon cassette includes a first case, a second case, a supply core, and a take-up core. Each of the first case and the second case includes a semi-cylindrical supply container and a semi-cylindrical take-up container formed in an integrated fashion. Each of the semi-cylindrical supply container and the semi-cylindrical take-up container includes bearings formed with a spacing therebetween in the lengthwise direction. The first case and a second case include positioning holes formed therein, and the positioning holes allow positioning pins provided on a printing apparatus to pass therethrough. Each of the supply core and the take-up core has a long ink ribbon wound therearound and includes a shaft rotatably supported by the corresponding bearings. The positioning holes are formed in one of the first case and the second case.

By employing such a structure, the positional shifts of the positioning holes due to the accuracy with which the first case and the second case are formed can be prevented when the first case and the second case are fitted together. As a result, when the ink ribbon cassette is mounted in a printing apparatus, each of the positioning pins of the printing apparatus is reliably inserted into the corresponding one of the positioning holes of the ink ribbon cassette, and therefore, the positioning accuracy of the ink ribbon cassette in the printing apparatus can be improved.

According to another aspect of the present invention, a printer includes a cassette mounting unit for allowing the above-described ink ribbon cassette inserted through an insertion port of the printing apparatus to be mounted therein, where one end of the supply shaft and one end of the take-up shaft of the ribbon cassette are fit to a supply bobbin and a take-up bobbin rotatably disposed in the deepest area of the cassette mounting unit, respectively. A guide member having an opening extending in the widthwise direction of the ink ribbon is disposed so as to be capable of moving, while passing through an opening of the ink ribbon cassette, between a position distant from a platen by a predetermined distance at a standby time of the printer and a position close to the platen at which a plurality of heating elements of a thermal head is capable of being pressed against the platen through the opening at a print execution time of the printer.

The guide member can have a U-shaped cross-section in a feed direction of the ink ribbon and the guide member having the U-shaped cross-section is open on the side remote from the platen. The above-described opening can be formed in the bottom wall of the guide member.

Additionally, a separation roller capable of separating the ink ribbon used for recording and fused to a recording paper sheet from the recording paper sheet can be rotatably supported by the guide member.

According to the present invention, as described above, the positional shifts of the positioning holes due to the accuracy with which the first case and the second case are formed can be prevented when the first case and the second case are fitted together. As a result, when the ink ribbon cassette is mounted in a printing apparatus, each of the positioning pins of the printing apparatus is accurately inserted into the corresponding one of the positioning holes of the ink ribbon cassette, and therefore, the positioning accuracy of the ink ribbon cassette in the printing apparatus can be improved.

Additionally, the printer that uses the ink ribbon cassette according to the present invention can use the guide member disposed at a print standby position of the printer and spaced from the platen by a predetermined distance as a guide member that guides the insertion of the ink ribbon cassette when the ink ribbon cassette is mounted in the printer. More specifically, by inserting the ink ribbon cassette into the printer so that the opening hole of the ink ribbon cassette is inserted along the wall having the opening hole of the guide member formed therein, the swing of the thermal head in a direction in which the thermal head moves close to or away from the ink ribbon cassette (hereinafter referred to as a “vertical direction”) in the cassette mounting unit can be reduced. Accordingly, the operation of fitting the ends of the supply shaft and the take-up shaft to the supply bobbin and the take-up bobbin can be simply and reliably carried out in the deepest area of the cassette mounting unit.

Additionally, as described above, the ribbon cassette is inserted into the cassette mounting unit such that the opening hole of the ribbon cassette is inserted along the bottom wall having the opening of the guide member formed therein, the side wall of the first container that contains the supply shaft of the ribbon cassette is inserted along the end walls extending vertically from the bottom wall upstream in the ink ribbon feed direction, and the side wall of the second container that contains the take-up shaft of the ribbon cassette is inserted along the end walls extending vertically from the bottom wall downstream in the ink ribbon feed direction. Thus, the swings of the thermal head in the vertical direction and the horizontal direction perpendicular to the vertical direction in the cassette mounting unit can be reduced. Accordingly, the operation of fitting the ends of the supply shaft and the take-up shaft to the supply bobbin and the take-up bobbin can be simply and reliably carried out in the deepest area of the cassette mounting unit.

Furthermore, in the printer using the ink ribbon cassette according to the present invention, since the separation roller moves vertically together with the guide member, the operation of mounting the ribbon cassette in the cassette mounting unit is simplified, compared with a printer having a structure in which the separation roller is secured at a predetermined location in the cassette mounting unit. Thus, the operability can be increased when the ribbon cassette is mounted in the printer.

### BRIEF DESCRIPTION OF THE DRAWINGS

FIG. 1 is a perspective view of an ink ribbon cassette according to an embodiment of the present invention;

FIG. 2 is an exploded perspective view of the ink ribbon cassette shown in FIG. 1;

FIG. 3 is a perspective view of a known ink ribbon cassette;

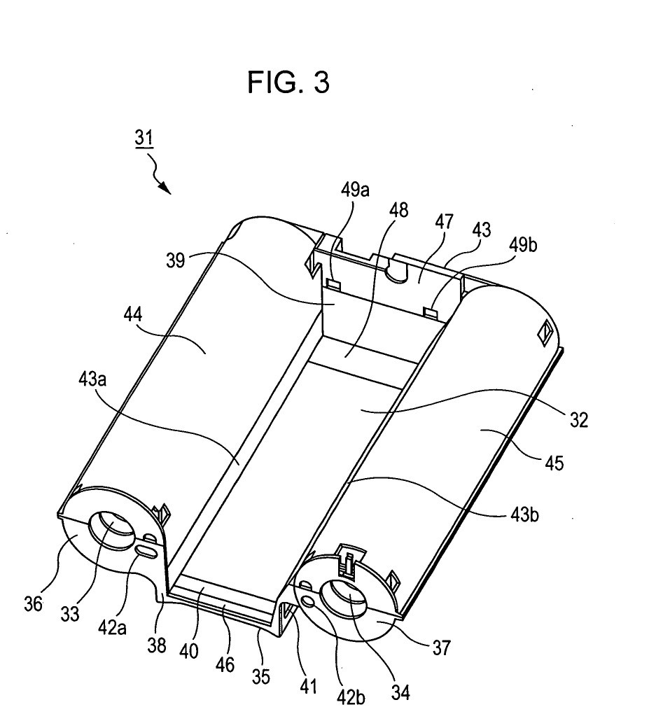

FIG. 4 is an exploded perspective view of the known ink ribbon cassette shown in FIG. 3;

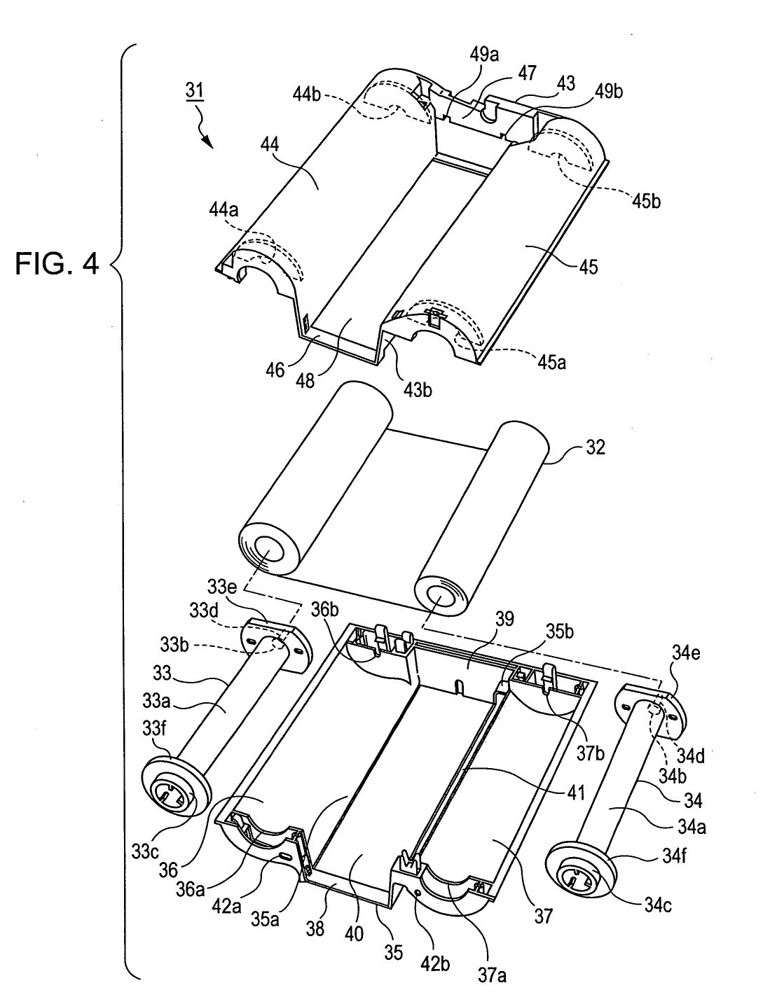

FIG. 5 is a front elevational view of a main portion of a housing of a printer according to an embodiment of the present invention;

FIG. 6 is a cross-sectional view of a main portion of the printer with a ribbon cassette mounted according to the embodiment of the present invention when a printer head is in the head up position; and

FIG. 7 is a cross-sectional view of the main portion of the printer with a ribbon cassette mounted according to the embodiment of the present invention when the printer head is in the head down position.

### DESCRIPTION OF THE PREFERRED EMBODIMENTS

An ink ribbon cassette and a printer according to exemplary embodiments of the present invention are described below with reference to the accompanying drawings.

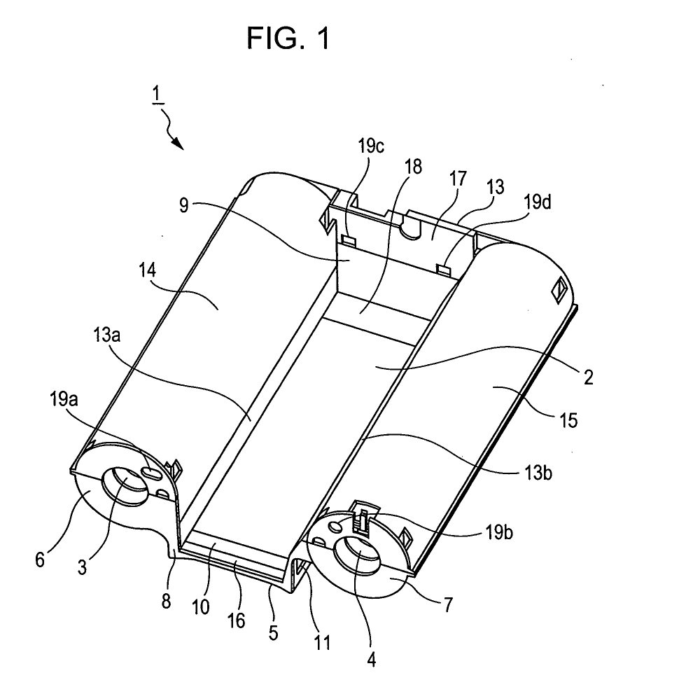

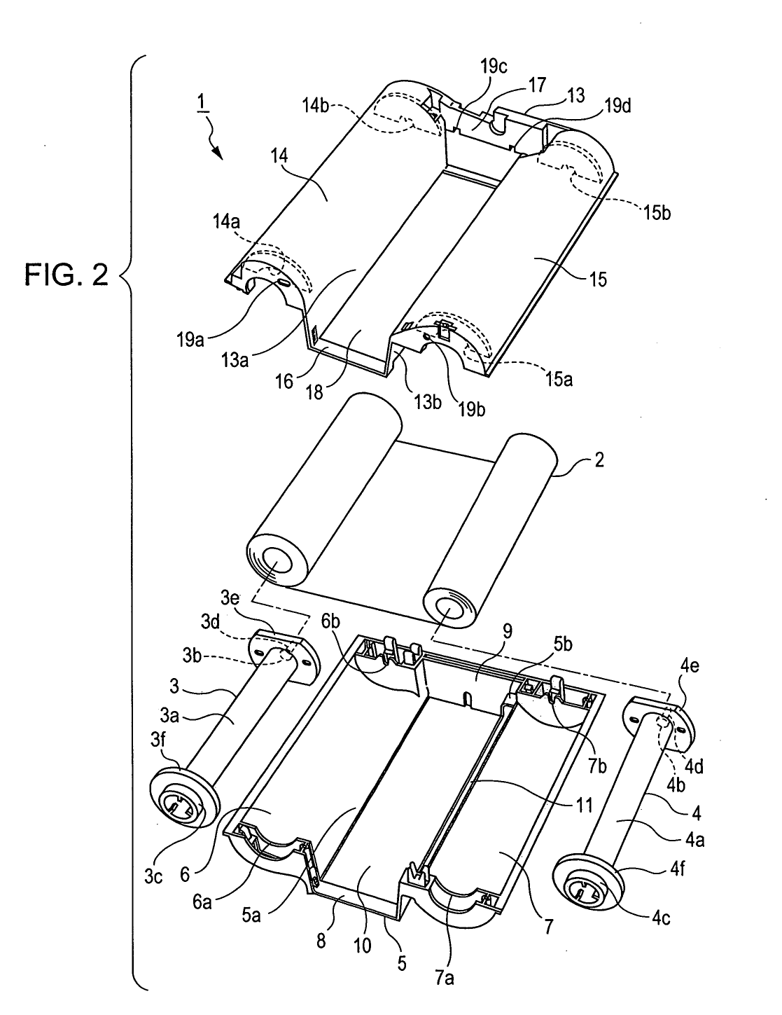

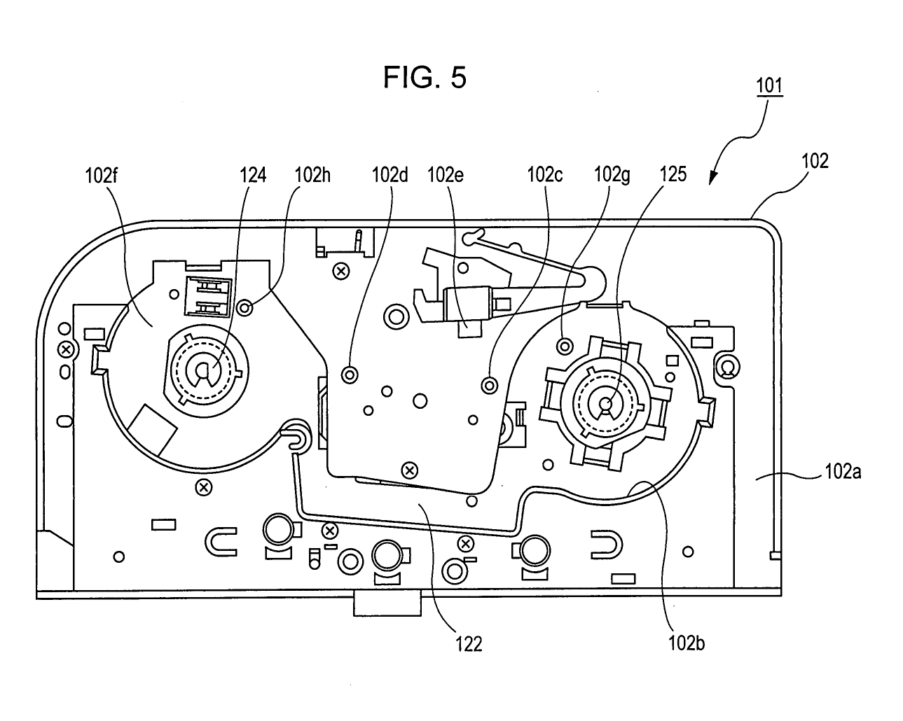

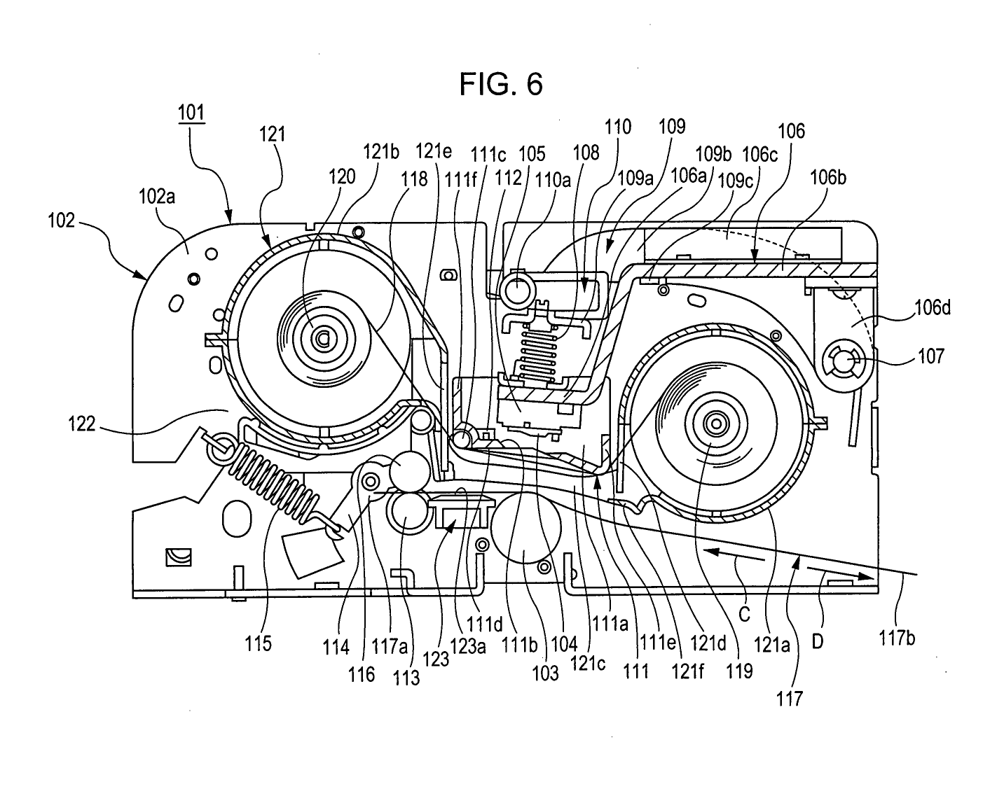

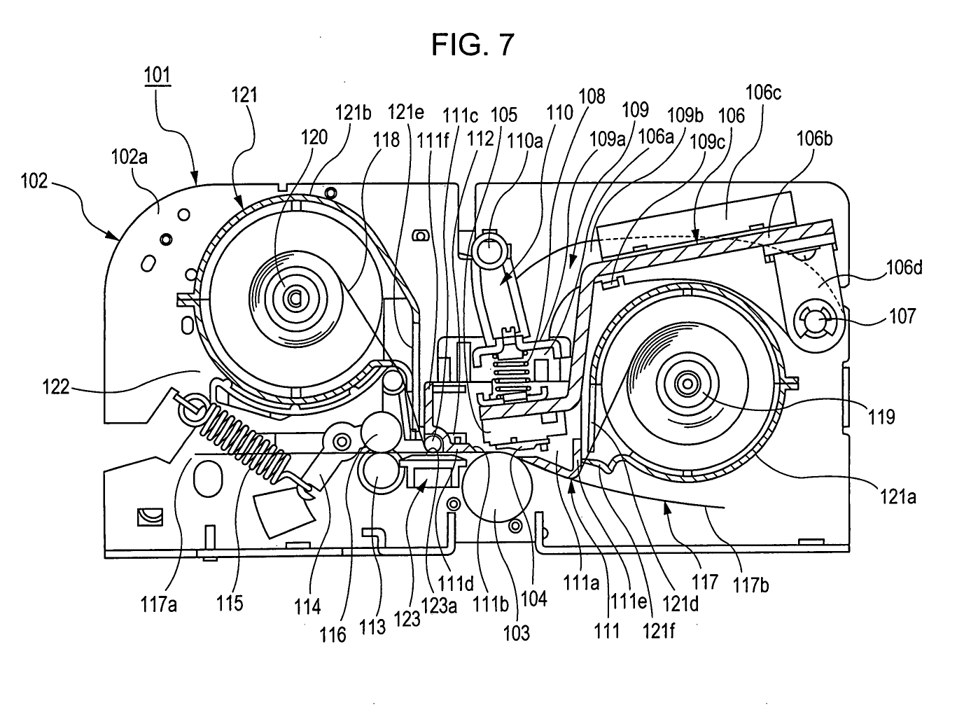

FIG. 1 is a perspective view of an ink ribbon cassette according to an embodiment of the present invention. FIG. 2 is an exploded perspective view of the ink ribbon cassette shown in FIG. 1. FIG. 5 is a front elevational view of a main portion of a body of a printer according to the embodiment of the present invention. FIG. 6 is a cross-sectional view of a main portion of the body of the printer with a ribbon cassette mounted according to an embodiment of the present invention when a printer head is in the head up position. FIG. 7 is a cross-sectional view of the main portion of the body of the printer with a ribbon cassette mounted according to the embodiment of the present invention when the printer head is in the head down position.

According to the present embodiment, as shown in FIGS. 1 and 2, an ink ribbon cassette 1 includes a first case 5 and a second case 13 that are fitted together. The first case 5 and the second case 13 rotatably support a supply core 3 with a long ink ribbon 2 wound therearound and a take-up core 4.

As shown in FIG. 2, the supply core 3 and the take-up core 4 are formed from substantially cylindrical resin members having the same size. The supply core 3 includes a cylindrical base portion 3a located in the middle in the axis direction, a small-diameter portion 3b located at one end in the axis direction and having an outer diameter smaller than that of the base portion 3a, and a large-diameter portion 3c located at the other end in the axis direction and having an outer diameter larger than that of the base portion 3a. A shaft 3d having a diameter smaller than that of the small-diameter portion 3b is coupled with the top end of the small-diameter portion 3b. Additionally, collar-like flanges 3e and 3f are integrally formed between the base portion 3a and the small-diameter portion 3b and between the base portion 3a and the large-diameter portion 3c, respectively. Similarly, the take-up core 4 includes a cylindrical base portion 4a located in the middle in the axis direction, a small-diameter portion 4b located at one end in the axis direction and having an outer diameter smaller than that of the base portion 4a, and a large-diameter portion 4c located at the other end in the axis direction and having an outer diameter larger than that of the base portion 4a. A shaft 4d having a diameter smaller than that of the small-diameter portion 4b is coupled with the top end of the small-diameter portion 4b. Additionally, collar-like flanges 4e and 4f are integrally formed between the base portion 4a and the small-diameter portion 4b and between the base portion 4a and the large-diameter portion 4c, respectively.

The first case 5 is formed from a resin material. As shown in FIGS. 1 and 2, the first case 5 includes a semi-cylindrical supply-side container 6, a semi-cylindrical take-up side container 7, a first side wall 8, and a second side wall 9. A first end of the supply-side container 6 and a first end of the take-up side container 7 in the lengthwise direction are coupled with the first side wall 8, whereas a second end of the supply-side container 6 and a second end of the take-up side container 7 in the lengthwise direction are coupled with the second side wall 9. Thus, the first case 5 is integrally formed. On the sides of the supply-side container 6 and the take-up side container 7 facing each other, a first ribbon guide 5a and a second ribbon guide 5b are integrally formed, respectively. Between the first ribbon guide 5a and the second ribbon guide 5b, an opening 10 is formed. The ink ribbon 2 is exposed through the opening 10. In addition, a guide roller clearance portion 11 is formed on the second ribbon guide 5b so as to extend in the lengthwise direction. When the ink ribbon cassette 1 is mounted in a printing apparatus (not shown), guide rollers (not shown) disposed on the printing apparatus to guide the ink ribbon 2 are in contact with the guide roller clearance portion 11.

As shown in FIG. 2, a semi-cylindrical shaft bearing 6a for rotatably supporting the large-diameter portion 3c of the supply core 3 and a semi-cylindrical shaft bearing 6b for rotatably supporting the shaft 3d of the supply core 3 are integrally formed in the supply-side container 6 of the first case 5. Additionally, a semi-cylindrical shaft bearing 7a for rotatably supporting the large-diameter portion 4c of the take-up core 4 and a semi-cylindrical shaft bearing 7b for rotatably supporting the shaft 4d of the take-up core 4 are integrally formed in the take-up side container 7 of the first case 5.

Like the first case 5, the second case 13 is formed from a resin material. As shown in FIGS. 1 and 2, the second case 13 includes a semi-cylindrical supply-side container 14, a semi-cylindrical take-up side container 15, a first side wall 16, and a second side wall 17. A first end of the semi-cylindrical supply-side container 14 and a first end of the take-up side container 15 in the lengthwise direction are coupled with the first side wall 16, whereas a second end of the supply-side container 14 and a second end of the take-up side container 15 in the lengthwise direction are coupled with the second side wall 17. Thus, the second case 13 is integrally formed. On the sides of the supply-side container 14 and the take-up side container 15 facing each other, a first ribbon guide 13a and a second ribbon guide 13b are integrally formed, respectively. An opening 18 is formed between the first ribbon guide 13a and the second ribbon guide 13b. The ink ribbon 2 is exposed through the opening 18. In addition, in each of the first ribbon guide 13a and the second ribbon guide 13b, a gap is formed when the first case 5 and the second case 13 are fitted together so that the ink ribbon 2 can pass between the first ribbon guide 5a and the second ribbon guide 5b of the first case 5.

As shown in FIG. 2, in the supply-side container 14 of the second case 13, a semi-cylindrical shaft bearing 14a for rotatably supporting the large-diameter portion 3c of the supply core 3 and a semi-cylindrical shaft bearing 14b for rotatably supporting the shaft 3d of the supply core 3 are integrally formed. Additionally, in the take-up side container 15 of the second case 13, a semi-cylindrical shaft bearing 15a for rotatably supporting the large-diameter portion 4c of the take-up core 4 and a semi-cylindrical shaft bearing 15b for rotatably supporting the shaft 4d of the take-up core 4 are integrally formed.

Furthermore, according to the present embodiment, as shown in FIGS. 1 and 2, positioning holes 19a, 19b, 19c, and 19d are formed on the supply-side container 14, the take-up side container 15, and the second side wall 17. Positioning pins (not shown) for positioning the ink ribbon cassette 1 in place in the printing apparatus are inserted into these positioning holes 19a-d when the ink ribbon cassette 1 is mounted in the printing apparatus.

A fitting member (not shown) for fitting the first case 5 to the second case 13 is integrally formed on each of the first case 5 and the second case 13. The shaft bearings 6a and 6b of the first case 5 and shaft bearings 14a and 14b of the second case 13 are disposed so as to rotatably support the supply core 3 with the ink ribbon 2 wound therearound. The shaft bearings 7a and 7b of the first case 5 and the shaft bearings 15a and 15b of the second case 13 are disposed so as to rotatably support the take-up core 4 with the ink ribbon 2 wound therearound. By fitting the first case 5 to the second case 13 using the fitting members, the ink ribbon cassette 1 is formed.

In the ink ribbon cassette 1 having such a structure according to the present embodiment, all of the positioning holes 19a, 19b, 19c, and 19d into which the positioning pins attached to the printing apparatus are inserted when the ink ribbon cassette 1 is mounted in the printing apparatus are formed in only the second case 13. Consequently, the positional shifts of the positioning holes 19a, 19b, 19c, and 19d due to the accuracy with which the first case 5 and the second case 13 are formed can be prevented when the first case 5 and the second case 13 are fitted together. Thus, when the ink ribbon cassette 1 is mounted in the printing apparatus, the positioning pins attached to the printing apparatus are accurately inserted into the positioning holes 19a, 19b, 19c, and 19d, thereby improving the positioning accuracy of the ink ribbon cassette 1 in the printing apparatus.

It should be noted that the present invention is not limited to the above-described embodiment. Various modifications can be made as needed. For example, in the above-described embodiment, the positioning holes 19a, 19b, 19c, and 19d are formed in the supply-side container 14, the take-up side container 15, and the second side wall 17 of the second case 13, respectively. However, the structure is not limited thereto. Even when the positioning holes 19a, 19b, 19c, and 19d are formed in the supply-side container 6, the take-up side container 7, and the second side wall 9 of the first case 5, respectively, the same advantage can be provided.

As shown in a front elevational view of FIG. 5, a printer 101 that adopts the ink ribbon cassette according to an aspect of the present invention includes a housing 102 composed of metallic plates. An insertion port 102b having a shape substantially that of eye-glasses is formed on a front side wall 102a of the housing 102. The insertion port 102b allows a ribbon cassette 121 to be inserted into a cassette mounting unit 122 in the printer 101 from the leading end of the ribbon cassette 121. A first positioning pin 102c and a second positioning pin 102d are provided so as to extend perpendicularly from the outer surface of the front side wall 102a with a predetermined pitch therebetween. Furthermore, in order to latch and secure the ribbon cassette 121 disposed in the cassette mounting unit 122, a claw member (a latching member) 102e is provided at a predetermined location on the front side wall 102a.

Furthermore, a supply bobbin 125 and a take-up bobbin 124 are rotatably disposed on the rear side wall 102f of the housing 102. The supply bobbin 125 and the take-up bobbin 124 protrude into the cassette mounting unit 122 of the printer 101 and fit a supply shaft 119 and a take-up shaft 120 contained in the ribbon cassette 121, respectively. In order to determine the position of the leading end of the ribbon cassette 121, a third positioning pin 102g and a fourth positioning pin 102h are provided so as to extend perpendicularly from the inner surface of the rear side wall 102f with a predetermined pitch therebetween.

As shown by cross-sectional views in FIGS. 6 and 7, inside the housing 102, a cylindrical platen (hereinafter referred to as a “platen roller”) 103 is rotatably supported by the front side wall 102a of the housing 102 and is disposed in the lower section of the housing 102. A thermal head 104 defining a long line head extending parallel to the axis of the platen roller 103 is disposed in the upper section of the housing 102 that faces the platen roller 103. A plurality of heating elements (not shown) are arranged on the surface of the thermal head 104 that faces the platen roller 103 so as to form a line in the lengthwise direction. The thermal head 104 is attached to a head supporter 106 via a head mount 105.

The head supporter 106 includes a head support portion 106a with the head mount 105 attached thereon and an extending portion 106b. The extending portion 106b extends from the head supporter 106 to the right in the drawing so as to have the shape of a cranked curve. A heat sink unit 106c is attached to the extending portion 106b so as to dissipate heat generated by the thermal head 104. A support arm 106d is attached downward on the right end of the heat sink unit 106c in the drawing. The support arm 106d is swingably supported by a support shaft 107, which bridges between the side walls of the housing 102 and is supported by the side walls of the housing 102. That is, the head supporter 106 swings about the support shaft 107 so that the thermal head 104 can be brought into contact with and move away from the platen roller 103 (i.e., head-down and head-up operations). In addition, the head support portion 106a of the head supporter 106 supports the lower end of a first coil spring 108. The upper end of the first coil spring 108 elastically presses against a pressure plate 109a of a pressure member 109. The pressure member 109 includes the elongated pressure plate 109a disposed parallel to the lengthwise direction of the thermal head 104 at one end. Either end of the pressure plate 109a is coupled with one end of each of two pivoting arms 109b. Additionally, the other ends of the two pivoting arms 109b are supported by the support shaft 107. When the pivoting arms 109b pivot about the support shaft 107, the pressure plate 109a moves upward and downward.

In the pressure member 109, part of the pivoting arm 109b is cut and is bent perpendicularly so as to form a stop 109c. The extending portion 106b of the head supporter 106 is latched to the stop 109c. Since the pressure member 109 is elastically pressed upward by a resilient member (not shown) at all times, the head supporter 106 and the pressure member 109 pivot upwards about the support shaft 107 when the pressure of the pressure plate 109a by a cam member 110 (described below) is released. Thus, the thermal head 104 moves upward. In addition, when the pressure plate 109a is pressed by the cam member 110 rotatably supported by a support shaft 110a, which is supported by the front side wall 102a, the pressure member 109 can move upward and downward.

According to the present embodiment, a guide member 111, which is separated from the head supporter 106, is disposed so as to surround the head mount 105 having the thermal head 104 mounted thereon. The guide member 111 is slightly smaller in size than a rectangular opening hole 121f (described below) formed in the ribbon cassette 121. The guide member 111 includes a bottom wall 111d having such a size that the bottom wall 111d can vertically pass through the opening hole 121f, two end walls 111e and 111f extending from the two sides of the bottom wall 111d in a feeding direction of an ink ribbon 118, and two side walls (not shown) vertically extending from the other two sides of the bottom wall 111d. The guide member 111 has a U-shaped cross section in the feeding direction of the ink ribbon 118 so as to be open on the side remote from the platen roller 103. The thermal head mount 105 of the thermal head 104 is disposed in a space 111a formed by the bottom wall 111d, the end walls 111e and 111f, and the two side walls. Furthermore, an opening 111b is formed in the bottom wall 111d so as to extend in the widthwise direction of the ink ribbon 118 and expose a plurality of the heating elements of the thermal head 104.

At the lower left corner of the guide member 111 in the drawing, a separation roller 111c is rotatably supported so as to separate the ink ribbon 118 that is fused to a recording paper sheet 117 when a printing operation is performed from the recording paper sheet 117 (described below). Additionally, an optical ribbon sensor 112 is disposed in the space 111a of the guide member 111 at the left of the opening 111b (downstream of the thermal head 104 in the feed direction of the recording paper sheet 117 indicated by arrow C, which will be described below). This ribbon sensor 112 detects the ink surface of the ink ribbon 118 (described below) and allows the start position of the ink ribbon 118 to be aligned with the print start position.

The guide member 111 is pressed by the resilient material (not shown) upward in a direction away from the platen roller 103 at all times. As shown in FIG. 6, in a print standby state in which the thermal head 104 is in a head-up state, the guide member 111 is also raised off the platen roller 103 by a predetermined distance. The guide member 111 having such a structure vertically moves through the opening hole 121f of the ribbon cassette 121 (described below) independently by means of the same driving source as for the cam member 110. Thus, the guide member 111 can move between the following two positions: one is a position distant from the platen roller 103 by the predetermined distance in the print standby state of the printer 101, namely, in the head-up state (see FIG. 6); and the other is a position at which the plurality of heating elements of the thermal head 104 is close to the platen roller 103 in order to press against the platen roller 103 through the opening 111b in a print execution state, namely, in the head-down state (see FIG. 7).

On the right of the platen roller 103 in the drawing, a first paper feed roller and a first pressure roller that presses against the first paper feed roller (neither is shown) are disposed. On the left of the platen roller 103 in the drawing, a second paper feed roller 113 and a second pressure roller 116 are disposed. The second paper feed roller 113 can rotate in the clockwise and counterclockwise directions by means of a driving force generated by a driving source (not shown). The second pressure roller 116 is pressed against the second paper feed roller 113 by a pressing force generated by a second coil spring 115 via a lever 114 and is driven by the second paper feed roller 113. In addition, the recording paper sheet 117, which is a printable thick sheet, is fed by the first paper feed roller and the first pressure roller that presses against the first paper feed roller in the direction indicated by arrow C between the thermal head 104 in the head-up state and the platen roller 103. Subsequently, the recording paper sheet 117 is pinched by the second paper feed roller 113 and the second pressure roller 116. The recording paper sheet 117 pinched by the second paper feed roller 113 and the second pressure roller 116 can be transported by the rotating second paper feed roller 113 in the direction indicated by arrow C and in the opposite direction indicated by arrow D. The recording paper sheet 117 is fed to the nip formed by the platen roller 103 and the thermal head 104 and is transported in the direction indicated by arrow C. A sheet sensor (not shown) is disposed upstream of the platen roller 103 in the feed direction in which the recording paper sheet 117 is normally fed. When the sheet sensor detects the leading edge 117a of the recording paper sheet 117 pinched by the second paper feed roller 113 and the second pressure roller 116 and identifies a print start point, the rotation of the second paper feed roller 113 temporarily stops.

Furthermore, the ink ribbon 118 is entrained above the recording paper sheet 117 between the thermal head 104 in the head-up state and the platen roller 103.

The width of the ink ribbon 118 is slightly greater than that of the recording paper sheet 117. The lower surface of the ink ribbon 118 shown in the drawing (the surface facing the recording paper sheet 117) has an ink surface thereon. The ink surface is slightly longer than the printable area of the recording paper sheet 117. For example, yellow (Y) ink, cyan (C) ink, or magenta (M) ink is applied to the ink surface.

A first marker including two black lines is formed in a transparent area between the C-color ink surface and Y-color ink surface. A second marker including one black line is formed in an area between the Y-color ink surface and M-color ink surface and in an area between the M-color ink surface and C-color ink surface. When the ribbon sensor 112 detects the first marker, the beginning of the first Y-color ink surface is identified. Similarly, when the ribbon sensor 112 detects the second marker, the beginning of the M-color ink surface or the C-color ink surface is identified. A transparent space portion is formed between the first marker (or the second marker) and the ink surface. The size of the space portion is slightly smaller than the distance between the heating element of the thermal head 104 and the ribbon sensor 112.

The ink ribbon 118 has a wide width and a long length. One end portion of the ink ribbon 118 is wound around the supply shaft 119. The other end portion is wound around the take-up shaft 120. The ink ribbon 118 is then stored in the ribbon cassette 121.

The ribbon cassette 121 includes a first container 121a for containing the supply shaft 119 with the unused ink ribbon 118 wound therearound and a second container 121b for containing the take-up shaft 120 with the used ink ribbon 118 wound therearound. A side of the first container 121a is connected to a side of the second container 121b in parallel with a predetermined spacing therebetween using two connecting members 121c.

A supply port 121d that allows the ink ribbon 118 wound around the supply shaft 119 to be drawn therethrough is formed in the first container 121a of the ribbon cassette 121 on the side adjacent to the connecting members 121c. In addition, a take-up port 121e is formed in the second container 121b on the side adjacent to the connecting members 121c.

The opening hole 121f is formed between the first container 121a and the second container 121b. The opening hole 121f allows the ink ribbon 118 that is drawn from the supply port 121d of the first container 121a and is collected into the take-up port 121e of the second container 121b to be exposed therethrough. In this embodiment, the opening hole 121f also allows the guide member 111 moving vertically to pass therethrough.

That is, the ribbon cassette 121 includes the rectangular opening hole 121f surrounded by the first container 121a, the second container 121b, and the two connecting members 121c and a substantially elliptical side wall (not shown) obtained by integrating the rear ends of the first container 121a and the second container 121b and one of the connecting members 121c that connects the rear ends thereof to each other. In this side wall, first and second positioning holes (not shown) for positioning the rear end of the ribbon cassette 121 are formed so as to correspond to the first and second positioning pins 102c and 102d of the printer 101, respectively. Additionally, in the rear wall, a latching hole (a latching member) to which the claw member (not shown) is latched is provided in order to secure and lock the ribbon cassette 121 disposed in the cassette mounting unit 122.

Additionally, circular side walls (top-side side walls) are formed on top portions of the first and second containers 121a and 121b that become the leading end when the two containers are inserted into the cassette mounting unit 122 of the printer 101. In order to determine the position of the leading end of the ribbon cassette 121, third and fourth positioning holes (not shown) are formed in the circular side walls so as to correspond to the third and fourth positioning pins 102g and 102h of the printer 101, respectively.

Furthermore, a sheet guide 123 is disposed in the feed path of the recording paper sheet 117 between the platen roller 103 and the second paper feed roller 113 so as to prevent the fed recording paper sheet 117 from deflecting downward. For example, a reflecting plate 123a having a glossy reflecting surface subjected to mirror finish is bonded to the sheet guide 123 using an adhesive agent.

A method for mounting the ribbon cassette 121 in the printer 101 having such a structure of this embodiment is now herein described. In the printer 101 according to this embodiment, the above-described guide member 111 is used as a guide member that guides the insertion of the ribbon cassette 121.

That is, the thermal head 104 is moved to the head-up position and the guide member 111 is raised. Thereafter, the ribbon cassette 121 is inserted into the cassette mounting unit 122 formed inside the housing 102 such that the opening hole 121f of the ribbon cassette 121 is inserted along the wall having the opening 111b of the guide member 111 formed therein, the side wall of the first container 121a that contains the supply shaft 119 of the ribbon cassette 121 is inserted along the end walls 111e extending vertically from the bottom wall 111d upstream in the ink ribbon feed direction, and the side wall of the second container 121b that contains the take-up shaft 120 of the ribbon cassette 121 is inserted along the end walls 111f extending vertically from the bottom wall 111d downstream in the ink ribbon feed direction. Thus, the ribbon cassette 121 is mounted in the cassette mounting unit 122.

At that time, at the front end of the ribbon cassette 121, the first and second positioning holes formed on the ribbon cassette 121 are engaged with the first and second positioning pins 102c and 102d formed on the printer 101, and the supply shaft 119 and the take-up shaft 120 contained in the above-described containers 121a and 121b fit the supply bobbin 125 and the take-up bobbin 124 of the printer 101. At the rear end of the ribbon cassette 121, the third and fourth positioning holes formed on the ribbon cassette 121 are engaged with the third and fourth positioning pins 102g and 102h formed on the printer 101. Thereafter, the claw member 102e serving as a latching member formed in the front side wall 102a of the printer 101 is latched to the latching hole serving as a latching member formed in the side wall. Thus, the operation of mounting the ribbon cassette 121 in the printer 101 is completed.

As noted above, in the printer 101 according to the present embodiment, by using the bottom wall 111d of the guide member 111 as a guide member for guiding the ribbon cassette 121 when being mounted, vertical swings of the ribbon cassette 121 in the cassette mounting unit 122 can be prevented. Furthermore, by using the end walls 111e and 111f extending vertically from the bottom wall 111d of the guide member 111 as guide members, horizontal swings of the ribbon cassette 121 in the cassette mounting unit 122 can be prevented. Accordingly, the operation of fitting the ends of the supply shaft 119 and the take-up shaft 120 to the supply bobbin 125 and the take-up bobbin 124 can be simply and reliably carried out in the deepest area of the cassette mounting unit 122. In addition, according to the present embodiment, since the separation roller 111c has a structure so as to move vertically together with the guide member 111, the operation of mounting the ribbon cassette 121 in the cassette mounting unit 122 is simplified, compared with a printer having a structure in which the separation roller is supported at a predetermined location in the cassette mounting unit 122. Thus, the operability can be increased.

The operation of the printer 101 having such a structure is briefly described next.

In an initial state of the printer 101, which is a print standby state, the thermal head 104 is in a head-up state. Also, the guide member 111 is raised, and therefore, the guide member 111 is separated from the platen roller 103. In such an initial state, which is a print standby state, the take-up shaft 120 rotates so as to take up the ink ribbon 118. The ribbon sensor 112 detects the first marker to align the beginning of the first Y-color ink surface with a predetermined position. Thereafter, the recording paper sheet 117 is fed to a space between the thermal head 104 (the guide member 111) in the initial state and the platen roller 103 from the left in the direction indicated by arrow C. The leading edge 117a of the recording paper sheet 117 is pinched by the second paper feed roller 113 and the second pressure roller 116 and is aligned with a predetermined position.

After the beginnings of the recording paper sheet 117 and the ink ribbon 118 are aligned, the cam member 110 is pivoted to press the pressure plate 109a of the pressure member 109 downward. Accordingly, the head supporter 106 pivots downward via the first coil spring 108, and therefore, the thermal head 104 starts to move downward. At the same time, the guide member 111 independently moves downward. Before the thermal head 104 is in tight contact with the platen roller 103, the lower surface of the guide member 111 presses against the recording paper sheet 117 so that the recording paper sheet 117 is reliably in contact with the peripheral surface of the platen roller 103. Therefore, even when the recording paper sheet 117 is curled, the guide member 111 can reliably press the curled recording paper sheet 117 against the platen roller 103. After the guide member 111 is lowered, the thermal head 104 moving downward presses the ink ribbon 118 and the recording paper sheet 117 against the platen roller 103.

Subsequently, the plurality of heating elements of the thermal head 104 are selectively heated in accordance with the print information and the recording paper sheet 117 is fed in the direction indicated by arrow C. Thus, the ink on the first Y-color ink surface of the ink ribbon 118 is transferred to the recording paper sheet 117, and therefore, a Y-color image is printed on the recording paper sheet 117. Thereafter, the thermal head 104 is moved upward and the guide member 111 is raised. Also, the recording paper sheet 117 is back-fed in a direction indicated by arrow D. Subsequently, the beginning of the recording paper sheet 117 is aligned with the predetermined position again and the thermal head 104 is moved downward. The ink on the M-color ink surface of the ink ribbon 118 is printed on the Y-color image, and therefore, an M-color image is overprinted on the Y-color image. By repeating such a printing operation, a desired color image can be printed on the recording paper sheet 117.

It should be noted that the present invention is not limited to the above-described embodiments. Instead, various modifications can be made as needed.

For example, the above-described guide member may be pressed by a resilient member at all times so as to be located at a position remote from the platen in the print standby state of the printer by a predetermined distance. By causing the thermal head moving from the head-up position to the head-down position to be brought into contact with the bottom wall of the hollow guide member, the guide member may be moved to a position close to the platen against the pressing force of the resilient member. By releasing the contact of the thermal head moving from the head-down position to the head-up position with the bottom wall of the hollow guide member, the guide member may be moved to the position remote from the platen by the predetermined distance again.

What is claimed is:

1. An ink ribbon cassette comprising:
a first case and a second case, each including a semi-cylindrical supply container and a semi-cylindrical take-up container formed in an integrated fashion, each of the semi-cylindrical supply container and the semi-cylindrical take-up container including bearings formed with a spacing therebetween in the lengthwise direction, the first case and a second case including positioning holes formed therein, the positioning holes allowing positioning pins provided on a printing apparatus to pass therethrough; and
a supply core and a take-up core, each having a long ink ribbon wound therearound and including a shaft rotatably supported by the corresponding bearings;
wherein the positioning holes are formed in one of the first case and the second case.

2. A printer comprising:
a cassette mounting unit for allowing the ink ribbon cassette according to claim 1 inserted through an insertion port of the printing apparatus to be mounted therein, one end of the supply shaft and one end of the take-up shaft of the ribbon cassette being fit to a supply bobbin and a take-up bobbin rotatably disposed in the deepest area of the cassette mounting unit, respectively;
wherein a guide member having an opening extending in the widthwise direction of the ink ribbon is disposed so as to be capable of moving, while passing through an opening of the ink ribbon cassette, between a position distant from a platen by a predetermined distance at a standby time of the printer and a position close to the platen at which a plurality of heating elements of a thermal head is capable of being pressed against the platen through the opening at a print execution time of the printer.

3. The printer according to claim 2, wherein the guide member has a U-shaped cross-section in a feed direction of the ink ribbon and the guide member having the U-shaped cross-section is open on the side remote from the platen, and wherein the opening is formed in the bottom wall of the guide member.

4. The printer according to claim 2, wherein a separation roller capable of separating the ink ribbon used for recording and fused to a recording paper sheet from the recording paper sheet is rotatably supported by the guide member.
